(19) United States
(12) Patent Application Publication
(10) Pub. No.: US 2006/0061518 A1
(43) Pub. Date: Mar. 23, 2006

(54) Angular and positional dependent vector display

(75) Inventors: Thomas A. Odegard, Albuquerque, NM (US); Steven P. Sanderson, Albuquerque, NM (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/215,047

(22) Filed: Aug. 30, 2005

Related U.S. Application Data
(60) Provisional application No. 60/612,438, filed on Sep. 23, 2004.

(51) Int. Cl. G09G 1/00

(52) U.S. Cl. 345/11

(57) ABSTRACT

A method for using an algorithm for autonomous, real-time computation of the inserted delays between successive calligraphic or stroke type vectors that optimizes both image quality and performance for systems that generate stroke video for cathode ray tube (CRT) type displays. The algorithm operates on parameters for vector angular change screen position, and stroke write rate or clock rate to determine an inner-vector delay and to optimize the image quality of the resulting vector graphics display. The algorithm can be implemented at a rudimentary level of the system level architecture and eliminates much of the tedious, manual effort associated with image quality optimization typically dictated by a vector display system.

### CROSS-REFERENCE TO RELATED APPLICATIONS

This application is based on U.S. Provisional Application Ser. No. 60/612,438 entitled “Variable Angular Change Stroke Delay”, filed on Sep. 23, 2004, the teachings of which are incorporated herein by reference.

### BACKGROUND OF THE INVENTION

1. Field of the Invention (Technical Field)

The present invention relates to Cathode Ray Tube (CRT) Displays and the electronic generation of display graphics using calligraphic or stroke-vector techniques and more particularly to an improvement to stroke symbology image quality based on angular change of the vectors being drawn on a CRT screen. The present invention provides an automatic delay insertion based on angular change of the vectors drawn.

2. Background Art

CRT type displays have a relatively slow response due to its electro-dynamic system. Implementing a display system that utilizes calligraphic or stroke-vector techniques to represent information contained within a video signal on a CRT display requires controlling the CRT's deflection amplifiers. The deflection amplifiers drive a set of coils that make up the magnetic yoke portion of a CRT. The magnetic yoke deflects a focused beam of high-speed electrons emitted from the cathode end of a vacuum tube onto the viewing (anode) end which is coated with a phosphorescent material. The signal bandwidth of the deflection amplifiers is severely limited due to the electrical properties of the magnetic yoke's coils which are resistive to current changes. The limited signal bandwidth of the deflection amplifiers creates a problem for stroke-vector graphics generating systems which require a dynamic response from the deflection amplifier circuitry in order to generate high-quality symbols and characters.

The problem manifests itself at the intersection of two vectors, when one vector ends and another vector begins. This transition of vector direction can require a signal bandwidth greater than what the CRT's electronic components are capable of effectively replicating. The result is the intersection becomes distorted or rounded rather than displaying a sharp transition between the two vectors. This limitation of the signal bandwidth of the deflection amplifiers of a CRT system is depicted in FIG. 1. FIG. 1 depicts how the limited signal bandwidth of the deflection amplifiers could negatively affect the image quality of a “W” character. Rather than forming the sharp corners 1 of the “W” character as shown, the corners are rounded 2.

Current technologies use predefined delays that are inserted manually in a predefined symbol set. An example of this is the use of a mechanism that inserts a pre-set delay between successive vectors to allow time for the deflection amplifiers and electron beam to settle as disclosed in U.S. Pat. No. 4,595,918. This settling time allows the beam to form a sharper transition between the two vectors by reducing the bandwidth of the deflection signals. This delay between the vectors is often referred to as an inter-vector delay and is either enabled or disabled. Further control of this method can be achieved by allowing a programmable delay time to be inserted between the vectors, thus allowing further optimization of the display image by allowing different delays to be programmed as required to improve overall image quality. This methodology provides the capability to overcome the root problem, but forces the system design to make trade-offs between throughput performance and time and effort spent performing a cumbersome manual optimization of the display graphics.

The function of the present invention is typically performed via a manual optimization of the display graphics for image quality using a variant of a system stall mechanism. This operation is normally performed during the building of the display formats versus the automated run-time approach presented in this disclosure. This system stall mechanism forces the system generating the stroke graphics video signals, which control the deflection amplifiers, to temporarily stall or wait after the completion of one vector before beginning the next vector. This stall can be accomplished by a few different approaches, but two of the most common are stopping or freezing the system clock or inserting some sort of no operation (NOP) command into the display list or state machine for the vector generator apparatus. Both of these methods can achieve the desired stall time between vectors to allow the electron beam to settle properly and overcome the sluggish response of the deflection amplifiers, but neither of these approaches achieves an automated optimum settling time as claimed in the present invention.

The shortcomings and disadvantages to the prior arts identified are system throughput reduction and manual optimization. The inter-vector delay approach can effectively optimize the display image if the delay is set large enough to compensate for the worst case signal bandwidth required by the deflection amplifiers to properly depict the intersection between two vectors. This delay will be substantially greater than the delay needed by most vector intersections. Thus, a system performance penalty will be incurred and the amount of vectors the system can effectively draw will be reduced. Depending on the system implementation, this methodology can also negatively affect the display refresh rate, induce noticeable flicker, and cause intensification or gaps at vector intersections. The use of a system stall mechanism has the disadvantage of being a manual operation requiring highly skilled personnel to perform this limited optimization. Thus, for every vector intersection on every display within the system, the number of NOP's or the duration of a system clock stall must be optimized. This can become a very tedious task depending on the complexity of the displays graphics and number of displays in the system.

Known systems for controlling cathode ray tube display monitors employ a topology to generate the deflection and video signals needed to control the direction and intensity of the electron beam within the cathode ray tube. The deflections signals, typically referred to as the “X” and “Y” signals, control the horizontal (X) and vertical (Y) movement of the electron beam by energizing magnetic coils or electrostatic deflection plates to deflect the beam. The video signal, also referred to as the “Z” signal, controls the intensity of the electron beam. The point at which the electron beam impinges upon a phosphorized screen is temporarily illuminated and the relative screen location and the intensity of the point are determined by magnitude of the “X”, “Y”, and “Z” signals. The continuous movement of the point to create a straight line segment, through the control of the “X” and “Y” signals, constitutes a vector with an intensity determined by the “Z” signal. One or more vectors are used to generate characters and symbols in the image being displayed on the cathode ray tube display monitor. The image persists on the face of the cathode ray tube for only a finite period of time and must be “refreshed”, typically at a rate of about 60 times per second, by redrawing the vectors which define the image being displayed.

Digital vector generators are typically utilized in modern systems employed to generate the deflection and video signals required by a cathode ray tube display monitor. Both closed-loop and open-loop variants of digital vector generators are known, with the open-loop variant providing additional system architecture flexibility as opposed to the closed-loop variant. The open-loop algorithm permits the use of either polar coordinate or rectangular coordinate format vectors along with constant velocity vector generation. The polar or rectangular coordinate format vector dictate the utilization of either the tangent algorithm or sine/cosine algorithm respectively. In the tangent algorithm, the deflection accumulator corresponding to the axis of the largest vector component is advanced by one integer unit or every clock cycle and the other accumulator is advanced by the tangent of the vector angle. In the sine/cosine algorithm, the X and Y coordinates are advanced each clock cycle by the cosine and sine, respectively, of the vector angle. A description of a tangent algorithm digital vector generator, to which the present invention is applicable, is disclosed in U.S. Pat. No. 4,115,863 issued Sep. 19, 1978. A description of a sine/cosine algorithm digital vector generator to which the present invention is applicable is disclosed in U.S. Pat. No. 4,481,605 issued Nov. 6, 1984.

There are a few known limitations to the inherent operation of a cathode ray tube display monitor related to image quality and system performance. The deflection amplifiers used to energize the magnetic coils or deflection plates have a limited signal bandwidth. This poises a system level issue when attempting to generate an accurate image representation of the vectors, especially at the beginning and end points of the vectors. This issue arises due to the corresponding change in direction of the vector at vector intersections and inherent bandwidth content of the deflection signals to control this direction change. The response of the electron beam may also become non-linear as the beam approaches the outer edges of the display surface. Another limitation of a cathode ray tube display monitor is the minimum refresh rate required to avoid screen flicker that is noticeable by the human eye. This minimum refresh rate defines a finite time period for each image and dictates the quantity of vectors that can be included in that image. Thus, as an image becomes more complex and contains a large quantity of symbols and characters the system may begin to approach or surpass the maximum time period required to guarantee the minimum refresh rate.

For systems that generate vector type signals to control a cathode ray tube display monitor, there has always been a tradeoff between the amount of information that can be accurately displayed in an image and the flicker associated with that image. Techniques to improve upon image quality such as slower vector write speeds and course delays inserted between vectors have a negative effect on screen flicker as the complexity of the displayed image increases. This invention addresses this system tradeoff by identifying a methodology that optimizes the delays in between vectors in an automated fashion to improve image quality while not burdening the system with excessive delays and reducing the information throughput of the system.

The invention differs from prior methods by automating the process of optimizing the duration of delay between successive vectors for image quality and system performance. This method requires less up-front work to characterize the delay characteristics for each display type and also provides a dynamic, on-the-fly delay calculation that the previous inventions lacked. State of the art approaches provide an adequate solution to overcome the limited signal bandwidth of the deflection amplifiers, but fail to provide a solution that is automated and addresses the trade-offs between image quality and system performance. The present invention discloses a real-time vector delay generator that improves image quality while not penalizing the overall system throughput.

### SUMMARY OF THE INVENTION (DISCLOSURE OF THE INVENTION)

The present invention relates generally to systems, and common practices employed, which generate calligraphic or stroke vector signals to display graphics on a cathode ray tube monitor. Specifically, the invention relates to the generation of the signals by digital vector generators used to control the X and Y deflection amplifiers used by cathode ray tube display monitors to control the deflection of the beam onto the viewing end of the vacuum tube. The invention discloses an automated methodology for overcoming the limited signal bandwidth of the deflection amplifiers to improve image quality while also optimizing system performance.

The present invention provides an automatic delay insertion based on angular change of the vectors drawn. A variable delay will be calculated based on the angular change of the vectors being drawn. For example, a larger angular change generally will result in a longer delay being inserted. By inserting longer delays between vectors with a significant angular change it will allow the CRT beam to settle slightly before changing directions. The overall effect is to sharpen the corners on stroke symbology on a stroke graphics driven CRT display system. This also allows the user to draw at higher stroke writing rates without sacrificing stroke image quality. This same concept, angular change delay, also applies to screen position in helping to determine the delay inserted between vectors based on screen position as well as angular change.

A primary object of the present invention is to provide an automated technique for vector generating display systems to address image quality issues associated with vector intersections and screen position while maximizing the amount of information that can be displayed for a given refresh period

A primary advantage of the present invention is its capacity to address the known limitations of vector generating display systems relative to image quality in real-time for both static and dynamic displays through the use of the angular change between successive vectors, absolute screen position, and vector write speed in determining an optimum vector delay to accurately represent vector intersections.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 depicts the effects of the distorted vector intersections on a stroke-vector character W. Rather than having sharp and defined corners for the W character, the corners are rounded and the overall image quality of the character is diminished.

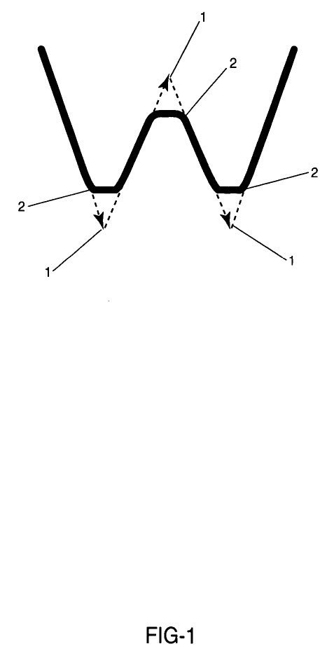

FIG. 2 is a block diagram of the preferred embodiment of the present invention.

FIG. 3 is a block diagram of the absolute positional embodiment of the present invention.

FIG. 4 graphically shows the display surface area of the cathode ray tube display to be divided into sixty-four quadrants using the present invention.

### DESCRIPTION OF THE PREFERRED EMBODIMENTS (BEST MODES FOR CARRYING OUT THE INVENTION)

The present invention provides an automated technique for vector generating display systems to address image quality issues associated with vector intersections and screen position while maximizing the amount of information that can be displayed for a given refresh period. The present invention improves prior art techniques of reduced bandwidth vectors within sine/cosine and tangent algorithm vector generators. The overall approach of the invention exploits the angular change of successive vectors, absolute screen position, and vector drawing speed to automatically optimize at run-time the necessary delay period to accurately display the vector intersection on a cathode ray tube display monitor.

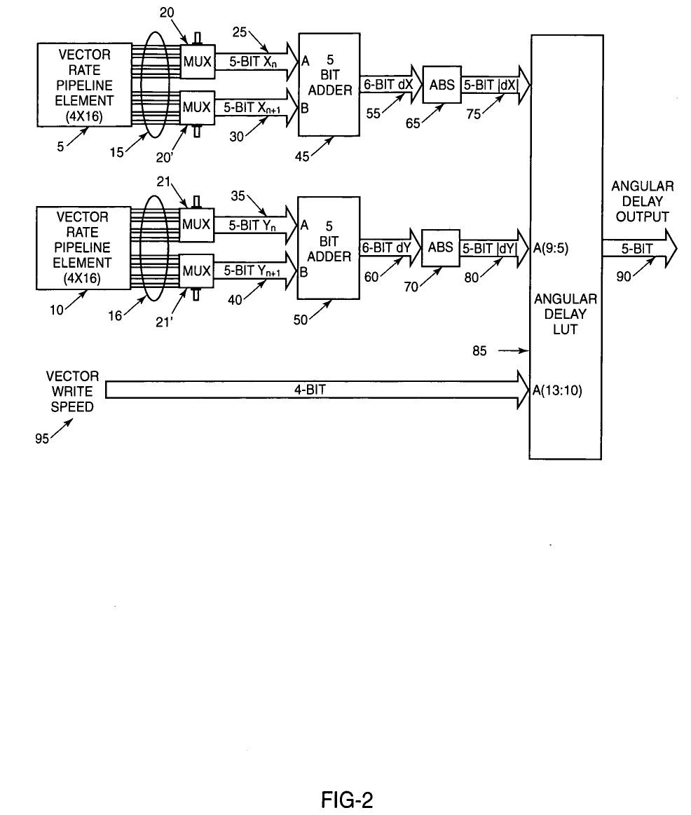

FIG. 2 is a block diagram of the angular change embodiment of the present invention and depicts the necessary functional components to implement an angular dependent vector delay within the architectures of known art for digital vector generators. Vector rate pipeline 5 and 10 are configured as a 16-bit, four deep shift registers and implemented to pipeline vector data. Vector pipeline 5 and 10 should contain the X and Y component change rate data for the current vector and the next three vectors during normal operation. The depth of four was arbitrarily chosen for the present embodiment, however the depth can be modified to meet the vector pipelining requirements of a specific system implementation of a digital vector generator. The loading of data into vector rate pipeline 5 and 10 is controlled by a vector state machine controller or a general-purpose microcomputer, the architecture of which are well known in the art. The data contained in vector rate pipeline 5 and 10 is change rate data for the X and Y components, respectively, for a specific vector as when implementing the sine/cosine algorithm for a digital vector generator. A value that is proportional to the cosine of the vector angle is stored in the vector rate pipeline 5 for the X component and a value that is proportional to the sine of the vector angle is stored in the vector rate pipeline 10 for the Y component. These values are generally represented with both an integer and fractional component. For this embodiment, the integer portion is defined as bits (15:11) and the fractional portion occupying bits (10:0). The representation of data may be altered to accommodate the resolution requirements of the specific system implementation. The cosine and sine values are typically normalized to a desired number of display increments, which correlates to the change (delta) in the X and Y components of a vector every system clock cycle. This normalization is implemented to define the display resolution within the voltage limits for a particular cathode ray tube display monitor. Vector rate pipelines 5 and 10 containing change rate data for the X and Y components of a vector are common elements implemented as part of systems based on prior art for deflection accumulator circuits (digital integrator) and is leveraged upon for the current invention.

The signed integer portion, bits (15:11), of the change rate data for the X and Y components of a vector stored in the four 16-bit registers of vector rate pipeline 5 and 10 and are connected via signal connections 15 and 16 to four-to-one multiplexers 20, 20′ and 21, 21′. Signal connections 15 and 16 connect the data contained in vector rate pipelines 5 and 10 to multiplexers 20 and 21 for the X and Y vector component change rate data, respectively. A first multiplexer 20 outputs the X vector component change rate data of the current vector to output 25, denoted Xₙ in FIG. 2. A second multiplexer 20′ outputs the X vector component change rate data of the next vector to be operated onto output 30, denoted Xₙ₊₁ in FIG. 2. A first multiplexer 21 outputs the Y vector component change rate data of the current vector to output 35, denoted Yₙ in FIG. 2. A second multiplexer 21′ outputs the Y vector component change rate data of the next vector to be operated on to output 40, denoted Yₙ₊₁ in FIG. 2. Multiplexers 20, 20′ and 21, 21′ are controlled by the same vector state machine controller or general-purpose microcomputer which controls vector rate pipeline 5 and 10 to multiplex both the current vector and the next vector for the X and Y component data into 5-bit adders 45 and 50, respectively, at the next stage of the circuit depicted in FIG. 2.

The 5-bit adders 45 and 50 are 2's compliment, 5-bit adders are used to determine the magnitude of the rate change for the X and Y components from the current vector to the next vector. The 5-bit adders 45 and 50 are two input adders, inputs A and B, that perform the operation A-B. The 2's compliment of the B input to the 5-bit adders 45 and 50 is calculated before the adder adds together the A and B inputs to generate the A-B output. The 5-bit adder 45 receives the current vector's X component change range 25 and the next vector's X component (Xₙ) change rate 30 for the X component (Xₙ₊₁) of the current and next vectors. The operation of the 5-bit adder 45 yields the 6-bit signed result of Xₙ-Xₙ₊₁ (dX) at 6-bit signed result 55. The 5-bit adder 50 receives the current vector's Y component (Yₙ) change range 35 and the next vector's Y component (Yₙ₊₁) change rate 40 for the Y component of the current and next vectors. The operation of the 5-bit adder 50 yields the 6-bit signed result of Yₙ-Yₙ₊₁ (dY) at 6-bit signed result 60. The 6-bit signed results 55 and 60 are connected to absolute (ABS) value circuits 65 and 70, which will generate the 2's compliment of 6-bit signed results 55 and 60 inputs if the value of the input is negative. The result of ABS circuits 65 and 70 are a 5-bit values for |dX| 75 and |dY| 80. The outputs of |dX| 75 and |dY| 80 of ABS circuits 65 and 70, respectively, are connected to angular delay look-up-table (LUT) 85.

Angular delay look-up-table 85 uses the calculated difference of the current vector to the next vector rate change magnitudes for the X and Y components of a vector to determine a delay count value to be inserted between the successive vectors. The bit values representing absolute X and Y differences |dX| 75 and |dY| 80, directly address the contents of angular delay look-up-table 85 at address bits (4:0) for the absolute change in X component (|dX|) and address bits (9:5) for the absolute change in Y component (|dY|). The current vector write or draw speed 95 is also used to address angular delay look-up-table 85 at address bits (13:10). Angular delay look-up-table 85 contains a collection of tables that contain optimized delay count values based on the change in angle between successive vectors. The tables are accessed by vector write speed 95 input to angular delay look-up-table 85. Vector write speed 95 input and corresponding angular delay look-up-table 85 allows the system to configure tables for different vector write speeds used in the system which may also have different display increment resolution settings. The contents of each table in the angular delay look-up-table 85 represent the delay necessary between successive vectors to properly display the vector intersection on the targeted cathode ray tube display monitor. The angular delay output 90 of angular delay look-up-table 85 is used by the controller of the vector generator system to determine the number of system clock cycles to delay between the successive vectors.

The contents of angular delay look-up-table 85 will be semi-specific to the actual system where the current invention is implemented as well as how the values in the look-up-tables are loaded or preset. The equation shown in EQ. 1 provides an initial starting point for angular based delays:
Delay=INT(N×\sqrt{(dX)²+(dY)²}) EQ.

The variable N is a multiplier that will increase or decrease the delay based upon the display increment and vector write speeds used in the system. Varying the value of N should correspond to the different tables of angular delays that are accessed by vector write speed 95. The dX and dY components are the delta in the normalized component, X and Y, rate changes based on the cosine and sine values of the current and next vector angles. The resultant's integer portion of the mathematical operation is used to determine the delay and is loaded or preset in the table.

The resolution and accuracy of the vector angle delta provided by the present invention can be altered by frequency of the system clock and/or modifying the amount of data bits operated upon by the circuit depicted in FIG. 2 and the delay values calculated by the equation depicted in EQ. 1, as required to optimize the display depending on the specific system implementation of the current invention. This disclosure has illustrated the utilization of the entire integer portion, four magnitude bits and one sign bit, of the change rate data for the X and Y components. Depending on the system implementation of the digital vector generator and the electrical response of the cathode ray tube display monitor being actively driven by the systems' deflection signals, the responsiveness of the present invention can be increased or decreased. The change in responsiveness is accomplished by increasing or decreasing the number of magnitude bits utilized within the architecture of the present invention and the clock rate at which the system operates. The current invention also allows for the individual optimization of the delays corresponding specific angular change magnitudes based upon visual inspection of the display for relative effectiveness of EQ. 1.

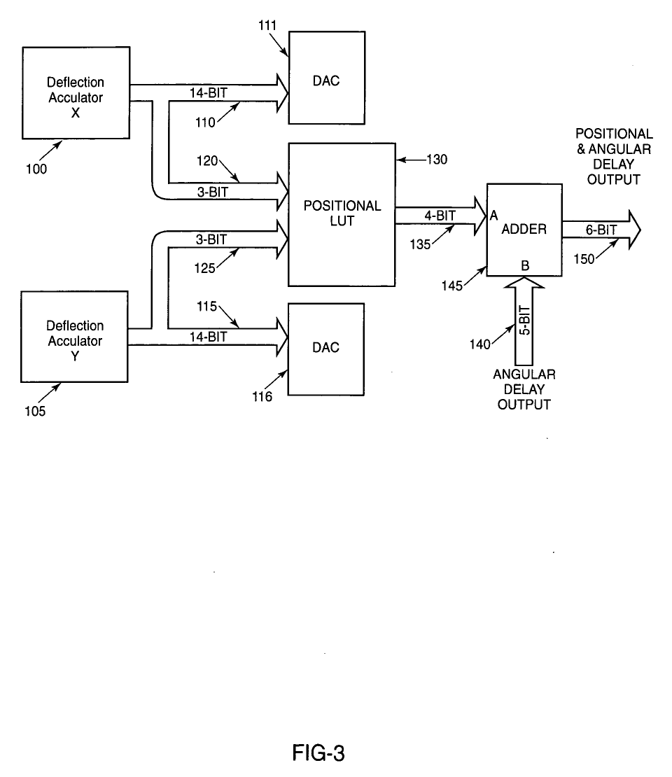

FIG. 3 is a block diagram of the absolute positional embodiment of the present invention and depicts the necessary functional components to implement a positional dependent vector delay, in combination with the angular change embodiment, within the architectures of known art for digital vector generators. The deflection accumulators for the X component 100 and Y component 105 are well known in the current art as well as digital-to-analog converters (DAC) 111 and 116. These components are employed within the architecture of a digital vector generator, and depict how the current invention works in unison with these components. The 14-bit connections 110 and 115 between deflection accumulators 100 and 105 and DAC's 111 and 116 were arbitrarily chosen based on current technology and the state of the known art and can be changed depending on the system implementation. The digital values represented by the 14-bit connections 110 and 115 contain the current X and Y position, respectively, of the electron beam of the cathode ray tube display monitor.

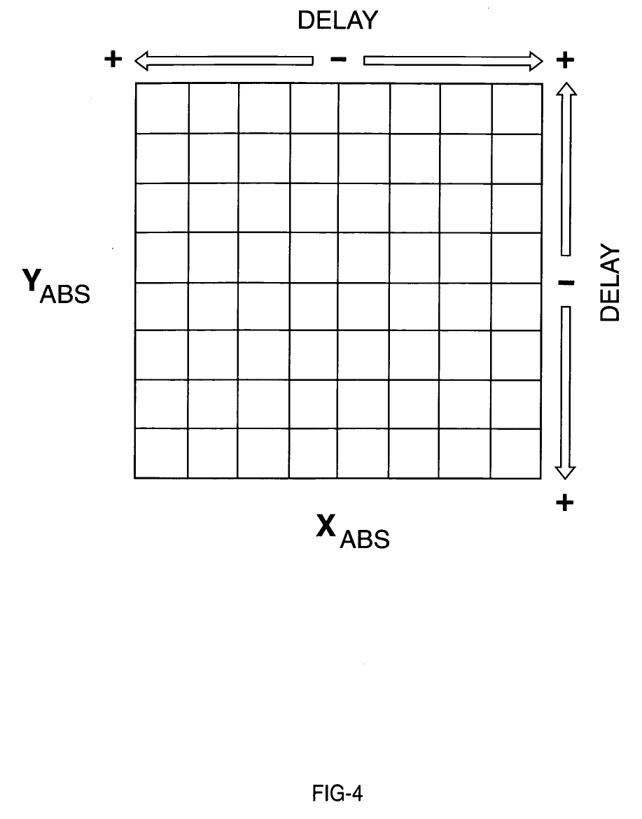

FIG. 3 depicts 3-bit connections 120 and 125 to 14-bit X and Y positional connections 110 and 115. The 3-bit connections 120 and 125 contain the three most significant bits of the absolute magnitude of the positional value contained on the signed 14-bit X and Y positional connections 110 and 115. The use of the three most significant bits of the absolute magnitude of the X and Y positional values allows the display surface area of the cathode ray tube display to be divided into sixty-four quadrants as depicted in FIG. 4. The 3-bit connections 120 and 125 are used to address positional look-up table (LUT) 130. Positional LUT 130 contains a 4-bit delay value that corresponds to each of the quadrants depicted in FIG. 4. The 4-bit delay values for each quadrant are optimized for a specific cathode ray tube display monitor and should be determined during system integration of the digital vector generator and the cathode ray tube display monitor based upon image quality. The 4-bit delay values stored or loaded into positional LUT 120 are output via 4-bit connection 135 and used by the controller of the digital vector generator to insert a subsequent delay between successive vectors. The resolution of the positional delay element can be increased or decreased by increasing or decreasing the number of X and Y positional bits 120 and 125 used to address positional LUT 120.

FIG. 3 also depicts how the positional delay embodiment can be implemented along with the angular change embodiment. The 4-bit positional delay 135 and the 5-bit angular change delay 140 are connected to an adder element 145 to provide a 6-bit delay 150. The resulting 6-bit delay 150 represents the delay necessary to accurately display the vector information based upon angular change between successive vectors and the absolute screen position of the vector intersection.

Although the current invention has been represented with typical hardware elements, the basic algorithms and methodologies are not limited to this architecture. The algorithms and methodologies disclosed here can be implemented within the software design of a system.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A method of automatically inserting a delay between vectors of a stroke graphics driven CRT display, the method comprising the steps of:
a) calculating an angular change between the vectors;
b) determining a positional placement of a vector intersection of the vectors;
c) determining a vector write rate;
d) calculating the delay based on the calculated angular change 85, the determined positional placement 130 and the determined vector write rate; and
e) inserting the calculated delay between the vectors.

2. The method of claim 1 wherein steps a) through e) are implemented through software.

3. The method of claim 1 wherein steps a) through e) are implemented through hardware.

4. The method of claim 1 comprising repeating steps a) through e) for successive vectors.

5. The method of claim 1 wherein the step of calculating the delay comprises providing angular delay lookup tables.

6. The method of claim 1 wherein the step of calculating the delay comprises implementing a computational circuit.

7. A method of automatically inserting a delay between vectors based on an angular change between the vectors of a stroke graphics driven CRT display, the method comprising the steps of:
a) calculating an angular change between the vectors;
b) calculating the delay based on the calculated angular change; and
c) inserting the calculated delay between the vectors.

8. The method of claim 7 further comprising the step of determining a write rate of the vectors and factoring the determined write rate into the step of calculating the delay.

9. The method of claim 7 wherein the step of calculating comprises providing angular delay look up tables.

10. The method of claim 7 wherein the step of calculating the delay comprises implementing a computational circuit.

11. The method of claim 7 comprising repeating steps a) through c) for successive vectors.

12. The method of claim 7 further comprising the step of determining an absolute positional placement of the vectors and factoring the determined positional placement into the step of calculating the delay.

13. A method of automatically inserting a delay between vectors based on an absolute positional placement of a vector intersection of the vectors of a stroke graphics driven CRT display, the method comprising the steps of:
a) determining the absolute positional placement of the vector intersection of the vectors;
b) calculating the delay based on the determined positional placement 130; and
c) inserting the calculated delay between the vectors.

14. The method of claim 13 wherein the step of calculating comprises providing absolute positional placement delay look up tables.

15. The method of claim 13 wherein the step of calculating the delay comprises implementing a computational circuit.

16. The method of claim 13 further comprising the step of determining an angular change of the vectors and factoring a calculated angular delay into the step of calculating the delay.

17. The method of claim 13 comprising repeating steps a) through c) for successive vectors.

18. An apparatus for automatically inserting a delay between vectors of a stroke graphics driven CRT display comprising:
a means for calculating an angular change between the vectors;
a means for determining a positional placement of a vector intersection of the vectors;
a means for determining a vector write rate;
a means for calculating the delay based on the calculated angular change, the determined positional placement and the determined vector write rate; and
a means for inserting the calculated delay between the vectors.
